(19) United States
(12) Patent Application Publication
(10) Pub. No.: US 2005/0247363 A1
(43) Pub. Date: Nov. 10, 2005

(54) Washing machine hose

(76) Inventor: William J. Selby, Stoughton, MA (US)

Correspondence Address: STEVEN N. FOX, ESQ., P.O. BOX 251, CANTON, MA, 02021, US

(21) Appl. No.: 10/841,969

(22) Filed: May 7, 2004

(51) Int. Cl. F16L 11/00

(52) U.S. Cl. 138/127; 138/123; 138/124; 138/126; 138/109

(57) ABSTRACT

The present invention is a safety hose for use in connecting a hot and/or cold water supply to a washing machine. The safety hose comprises a flexible hose assembly having first and second end portions. The flexible hose assembly further comprises a flexible inner liner having an annular wall thickness of about 0.070 inches to 0.080 inches and an inside diameter in the range of 0.370 to 0.380 inches. The flexible inner liner is made from synthetic rubber. The flexible hose assembly further comprises an intermediate layer made from a closed mesh braided wire having a diameter of 0.040 inches and disposed about the flexible inner liner. The flexible hose assembly further comprises a flexible cover disposed about the intermediate layer. The flexible cover has a thickness in the range of 0.070 to 0.080 inches. The flexible cover is made from synthetic rubber and is chemically bonded to the intermediate layer and flexible inner liner. The safety hose further comprises a first connector fitting engaged with the first end portion of the flexible hose assembly. The first connector fitting comprises a brass nut engageable with the washing machine. The first connector fitting further comprises a brass ferrule and a brass insert securely engaged with the first end portion of the flexible hose assembly by internal and external crimps. The safety hose further comprises a second connector fitting engaged with the second end portion of the flexible hose assembly. The second connector fitting comprises a brass nut engageable with the hot water supply. The second connector fitting further comprises a brass ferrule and a brass insert securely engaged with the second end portion of the flexible hose assembly by internal and external crimps.

### FIELD OF THE INVENTION

The present invention relates to mechanical hoses for use in connecting a washing machine to a hot and/or cold water supply.

### BACKGROUND OF THE INVENTION

A variety of flexible hoses have been developed to connect a washing machine a hot and/or cold water supply. Such conventional designs typically include the use of a single hose made of rubber and steel and connector fittings made from steel. Such conventional have several drawbacks. For example, such conventional safety hoses may fail over prolonged use by water leaking from the hose or from the engagement of the hose with the connector fittings. Such failures appear to occur due to heat, water pressure, and/or corrosion of the steel connector fittings.

### SUMMARY OF THE INVENTION

The present invention is a safety hose for use in connecting a hot and/or cold water supply to a washing machine. The safety hose comprises a flexible hose assembly having first and second end portions. The flexible hose assembly further comprises a flexible inner liner having an annular wall thickness of about 0.070 inches to 0.080 inches and an inside diameter in the range of 0.370 to 0.380 inches. The flexible inner liner is made from synthetic rubber. The flexible hose assembly further comprises an intermediate layer made from a closed mesh braided wire having a diameter of 0.040 inches and disposed about the flexible inner liner. The flexible hose assembly further comprises a flexible cover disposed about the intermediate layer. The flexible cover has a thickness in the range of 0.070 to 0.080 inches. The flexible cover is made from synthetic rubber and is chemically bonded to the intermediate layer and flexible inner liner. The safety hose further comprises a first connector fitting engaged with the first end portion of the flexible hose assembly. The first connector fitting comprises a brass nut engageable with the washing machine. The first connector fitting further comprises a brass ferrule and a brass insert securely engaged with the first end portion of the flexible hose assembly by internal and external crimps. The safety hose further comprises a second connector fitting engaged with the second end portion of the flexible hose assembly. The second connector fitting comprises a brass nut engageable with the hot water supply. The second connector fitting further comprises a brass ferrule and a brass insert securely engaged with the second end portion of the flexible hose assembly by internal and external crimps.

### BRIEF DESCRIPTION OF THE DRAWINGS

The following detailed description of the invention will be more fully understood with reference to the accompanying drawings in which:

FIG. 1 is a plan view of a safety hose of the present invention engageable with a washing machine and a hot and/or cold water supply;

FIG. 2 is a cross-section view taken along line 2-2 of FIG. 1; and

FIGS. 3 and 4 are cross-section views taken along line 3-3 of FIG. 1.

### DETAILED DESCRIPTION OF THE PREFERRED EMBODIMENTS

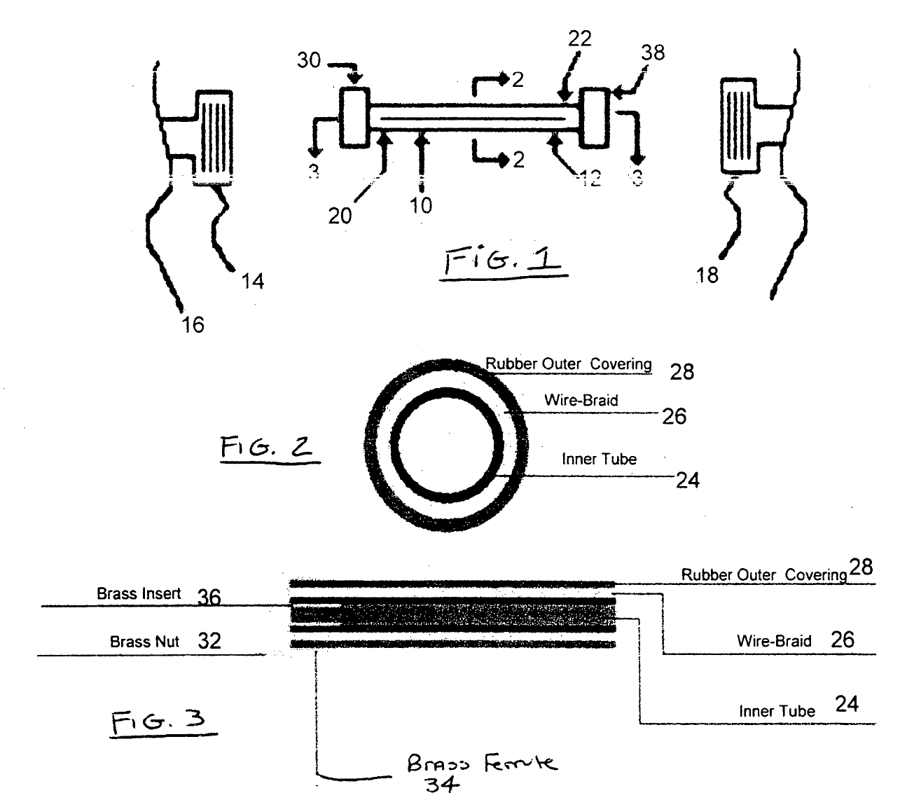

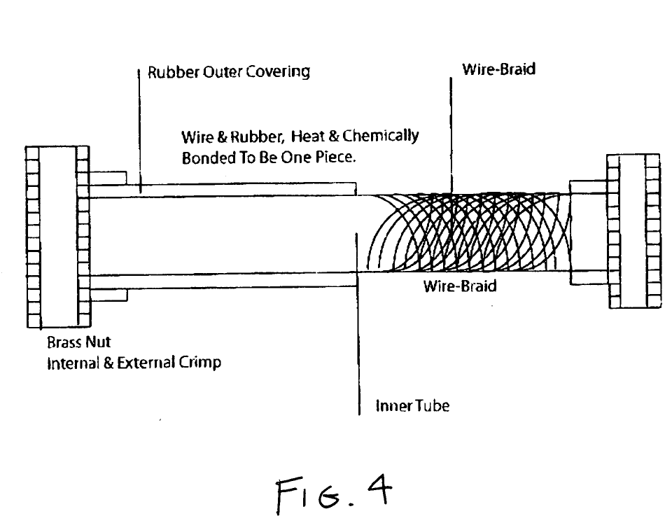

Referring to FIGS. 1-3, the safety hose 10 of the present invention generally comprises a flexible hose assembly 12 engageable with the water intake spout 14 of a washing machine 16 and a hot and/or cold water supply or spout 18.

The flexible hose assembly 12 comprises first and second end portions 20 and 22. The flexible hose assembly 12 further comprises a flexible inner liner 24 having an annular wall thickness of about 0.070 inches to 0.080 inches and an inside diameter in the range of 0.370 to 0.380 inches. The flexible inner liner 24 is made from synthetic rubber. The flexible hose assembly 12 further comprises an intermediate layer 26 made from a closed mesh braided wire having a diameter of 0.040 inches (20 gauge wire) and disposed about the flexible inner liner 24. The flexible hose assembly 12 further comprises a flexible cover 28 disposed about the intermediate layer 26. The flexible cover 28 has a thickness in the range of 0.070 to 0.080 inches. The flexible cover 28 is made from synthetic rubber and is chemically bonded to the intermediate layer 26 and flexible inner liner 24.

The safety hose 12 further comprises a first connector fitting 30 securely engaged with the first end portion 20 of the flexible hose assembly 12. The first connector fitting 30 comprises a brass nut 32 engageable with water intake 14 of the washing machine 16. The first connector fitting 30 further comprises a brass ferrule 34 and a brass insert 36 securely engaged with the first end portion 20 of the flexible hose assembly 12 by internal and external crimps.

The safety hose 12 further comprises a second connector fitting 38 engaged with the second end portion 22 of the flexible hose assembly 12. The second connector fitting 38 comprises a brass nut 40 engageable with the hot or cold water supply 18. The second connector fitting 38 further comprises a brass ferrule 42 and a brass insert 44 securely engaged with the second end portion 22 of the flexible hose assembly 12 by internal and external crimps.

Unlike conventional devices, the safety hose 10 of the present invention can safely operate without failure at water temperatures as high as 250° F. and a pressure of 1000 psi. The dimensions and material of the flexible inner line 24, intermediate layer 26, flexible cover 28, and connector fittings 30 and 38, as stated heretofore, are critical to the safe and prolonged use of the safety hose 10 at water temperatures as high as 250 F. and a pressure of 1000 psi. The flexible hose assembly 12 may be obtained according to the specifications disclosed heretofore from Good Year Tire and Rubber Company. The brass connector fittings 30 and 38 may be obtained according to the specifications disclosed heretofore from Winnzler Stamping, Montpelier, Ohio 43543.

The foregoing description is intended primarily for purposes of illustration. This invention may be embodied in other forms or carried out in other ways without departing from the spirit or scope of the invention. Modifications and variations still falling within the spirit or the scope of the invention will be readily apparent to those of skill in the art.

1. A safety hose for use in connecting a hot and/or cold water supply to a washing machine, the safety hose comprises:
(a) a flexible hose assembly having first and second end portions, said flexible hose assembly comprising a flexible inner liner having an annular wall thickness of about 0.070 inches to 0.080 inches and an inside diameter in the range of 0.370 to 0.380 inches; said flexible inner liner being made from synthetic rubber; said flexible hose assembly further comprises an intermediate layer made from a closed mesh braided wire having a diameter of 0.040 inches and disposed about said flexible inner liner; said flexible hose assembly further comprising a flexible cover disposed about said intermediate layer; said flexible cover has a thickness in the range of 0.070 to 0.080 inches; said flexible cover is made from synthetic rubber and is chemically bonded to said intermediate layer and said flexible inner liner;
(b) a first connector fitting engaged with said first end portion of said flexible hose assembly, said first connector comprising a brass nut engageable with the washing machine; said first connector further comprising a brass ferrule and a brass insert securely engaged with said first end portion of said flexible hose assembly by internal and external crimps; and
(c) a second connector fitting engaged with said second end portion of said flexible hose assembly, said second connector fitting comprising a brass nut engageable with the hot water supply; said second connector fitting further comprising a brass ferrule and a brass insert securely engaged with said second end portion of said flexible hose assembly by internal and external crimps.
